(19) United States
(12) Patent Application Publication
(10) Pub. No.: US 2002/0091762 A1
(43) Pub. Date: Jul. 11, 2002

(54) Information display system and methods

(75) Inventors: Henry H. Sohn, Palo Alto, CA (US); Ronald Jacoby, Cupertino, CA (US); Brian Bushman, Santa Clara, CA (US); Anand Srinivasan, Sunnyvale, CA (US); Dean Burris, Kennesaw, GA (US); Justin Madison, Richardson, TX (US); Steve Linowes, Atlanta, GA (US); Johnny J. Speaks, Marietta, GA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yahoo! Inc., Santa Clara, CA

(21) Appl. No.: 09/801,439

(22) Filed: Mar. 7, 2001

Related U.S. Application Data
(60) Provisional application No. 60/187,683, filed on Mar. 8, 2000.
(60) Provisional application No. 60/198,713, filed on Apr. 20, 2000.

(51) Int. Cl. G06F 15/16

(52) U.S. Cl. 709/203

(57) ABSTRACT

Systems and methods for displaying real time media broadcasts with pages of related information. The systems and methods allow a user to interact with related online information while simultaneously viewing a video presentation or listening to an audio presentation. A client application executing on a client system processes a streaming data signal and displays an associated real time media presentation, live or archived, on one portion of a display. Reference data pushed to the client application in the streaming data signal identifies pages of related information. The client application retrieves the pages, e.g., via HTTP requests, and displays the pages in a data frame on a second portion of the display. The pages can be created in advance of the media presentation, and when retrieved and displayed, include current information related to the subject matter of the media presentation. Information included in the pages can include links to other related information. Upon selection of a link by a user, the link is passed to an active browser window displayed on a third portion of the display. The user may interact with information in the browser window and data frame while simultaneously viewing the real time media presentation.

### CROSS-REFERENCES TO RELATED APPLICATIONS

This application is related to U.S. Provisional Patent Application Serial No. 60/187,683 (Atty. Docket No. 017887-005100), filed Mar. 8, 2000, entitled “FINANCIAL INFORMATION DISPLAY,” and U.S. Provisional Patent Application Serial No. 60/198,713 (Atty. Docket No. 017887-005000), filed Apr. 20, 2000, entitled “MEDIA AND INFORMATION DISPLAY SYSTEMS AND METHODS,” the disclosures of which are each hereby incorporated by reference in its entirety.

### BACKGROUND OF THE INVENTION

The present invention relates generally to systems and methods for displaying media content, and more particularly to systems and methods for displaying real-time media content with a simultaneous interactive display of related text and reference information.

Streaming audio and video media players capable of displaying real time video and audio content are currently available and allow computer users to view and listen to real time video and audio presentations. Typically, however, if a user desires to obtain online information related to the real time media presentation, the user must either interrupt the media presentation or wait until the presentation is completed to search for the desired information. For example, if a user desires to obtain a stock quote or other information about a certain company that is the subject of the media presentation, the user must switch over to a browser and locate a stock quote page, enter a URL if known, or enter search terms to locate the desired information. Such a procedure is generally undesirable as it can be time consuming and impractical to switch to a browser and perform searches. Such a procedure is particularly undesirable in the case of a live video or audio broadcast. For example, if the user does not wish to wait until the end of the broadcast, the user must interrupt and miss part of the broadcast.

Accordingly it is desirable to provide a system that allows a user to view a real time media content and simultaneously view, obtain and interact with online information that is related, or unrelated, to the media content.

### SUMMARY OF THE INVENTION

The present invention provides systems and methods that allow a user to view real time streaming media content and simultaneously view, obtain and interact with online information related, or unrelated, to the real time content.

The systems and methods of the present invention allow a user to interact with related online information while simultaneously viewing a video presentation or listening to an audio presentation. A client application executing on a client system processes a streaming data signal and displays an associated real time media presentation, live or archived, on one portion of a display. Reference data pushed to the client application in the streaming data signal identifies pages of related information. The client application retrieves the pages, e.g., via HTTP requests, and displays the pages in a data frame on a second portion of the display. The pages can be created in advance of the media presentation, and when retrieved and displayed, include current information related to the subject matter of the media presentation. Information included in the pages can include links to other related information. Upon selection of a link by a user, the link is passed to an active browser window displayed on a third portion of the display. The user may interact with information in the browser window and data frame while simultaneously viewing the real time media presentation.

The techniques of the present invention are particularly useful for integrating a presentation of real-time data broadcast content with a concurrent display of related information, such as HTML text and references. In preferred aspects, such real-time data broadcast content includes video and/or audio data, live or archived, and the related information includes related text and graphical data and references such as selectable HTML links pushed to a push client.

Specific examples relating to finance news and information content are shown herein. However, it should be apparent that the present invention is applicable to any type of media content and related text and reference information, for example, live sporting event broadcasts with a concurrent display of related text and/or links to related web sites, shopping and auction broadcasts, live or archived, with related information and/or links to related web sites, etc.

According to the invention, an application module executing on a client system allows a user to view real time streaming video broadcast channels, or listen to real time streaming audio broadcast channels, and simultaneously view and interact with related information provided on a graphical user interface. For example, the user is able to access and view web pages including information relevant to the current topic of a real time video presentation, wherein the web pages displayed may be updated in real time to correspond with the current topic. Additionally, the user is able to conduct online trades, information searches, etc. with an active browser, and view and interact with a personal online portfolio, while concurrently viewing the real time streaming media broadcast channel.

According to one aspect of the invention, a computer implemented method is provided for displaying interactive media content. The method typically comprises the steps of receiving a data stream from a first server system over a network connection, wherein the data stream includes a first data portion corresponding to a real time media presentation and a second data portion identifying data for a related web page stored on a second server system, processing the first data portion to produce the real time media presentation, automatically retrieving the web page data from the second server, and simultaneously displaying the real time media presentation and the web page on different portions of a display.

According to another aspect of the invention, a computer implemented method is provided for displaying interactive media content. The method typically comprises the steps of receiving a first data stream from a first server system over a network connection, wherein the first data stream includes a first data portion corresponding to a real time media presentation and a second data portion including an IP address identifying data for a web page on a second server system, processing the first data portion using a media player module to produce the real time media presentation, and displaying the real time media presentation in a first portion of a display. The method also typically includes automatically sending a request for the web page data to the second server system using the IP address, receiving the web page data from the second server system, processing the web page data using a browser module to produce the web page, and displaying the web page on a second portion of the display simultaneous with displaying the real time media presentation.

According to yet another aspect of the invention, an information display system is provided. The system typically comprises a first server that provides data associated with a web page in response to a data request, a second server that provides a data stream including streaming data associated with a real time media presentation and reference data identifying the web page data on the second server, and a client application executing on a client device communicably coupled to the first and second servers over the Internet, the client device including a display. The client application is typically configured to receive the data stream, process the streaming data to produce the real time media presentation, automatically retrieve the web page data from the first server using the reference data, and process the web page data to produce the web page. In typical operation, the real time media presentation and the web page are simultaneously displayed on different portions of the display.

According to a further aspect of the invention, a computer implemented method is provided for displaying interactive media content. The method typically comprises displaying a real time media presentation on a first portion of a display, wherein the real time media presentation is based on streaming data received from a first server system, simultaneously displaying a web page on a second portion of the display, wherein the web page is automatically retrieved from a second server system using reference data included in the streaming data, and simultaneously displaying an active browser window on a third porion of the display.

According to yet a further aspect of the present invention, a computer-readable medium containing computer code for controlling a computer system to process media content is provided. The computer system is typically communicably coupled to first and second server systems over the Internet, wherein the computer system includes a processing unit and a display, wherein the first server system provides data associated with a web page in response to a data request, and wherein the second server system provides a data stream including streaming data associated with a real time media presentation and reference data identifying the web page data on the second server system. The computer code typically includes instructions for receiving the data stream from the second server system, processing the streaming data to produce the real time media presentation, automatically retrieving the web page data from the first server system using the reference data, processing the web page data to produce the web page, and simultaneously displaying the real time media presentation and the web page on different portions of the display. The computer code is typically provided by downloading from a remote source and storing on a computer readable medium such as ROM or RAM in the computer system. Alternatively, the code is provided on a computer readable medium such as a floppy disk, CD or DVD, or other medium.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a general overview of an information retrieval and communication system according to an embodiment of the present invention;

FIG. 2 illustrates an information retrieval and communication network for communicating media content according to an embodiment of the invention;

FIG. 3 illustrates an example of a graphical user interface (GUI) display created by the client application according to an embodiment of the present invention;

FIG. 4 illustrates another example of a GUI display created by the client application according to an embodiment of the present invention;

FIG. 5 is a block diagram of encoder system 170 according to an embodiment of the present invention; and

FIG. 6 illustrates an expanded view of server system 160 according to an embodiment of the present invention.

### DESCRIPTION OF THE SPECIFIC EMBODIMENTS

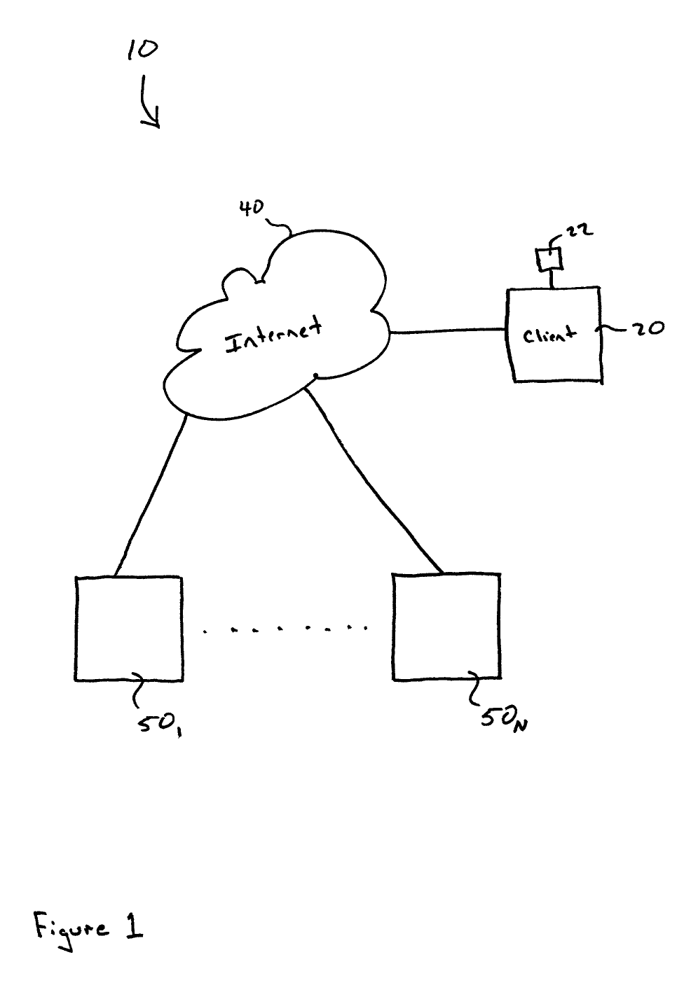

FIG. 1 illustrates a general overview of an information retrieval and communication network 10 including a client system 20 according to an embodiment of the present invention. In computer network 10, client system 20 is coupled through the Internet 40, or other communication network, e.g., over any LAN or WAN connection, to server systems 50ₗ to 50_{N}. As will be described herein, client system 20 is configured according to the present invention to communicate with any of server systems 50ₗ to 50_{N}, e.g., to access, receive, retrieve and display media content and other information such as web pages.

Several elements in the system shown in FIG. 1 include conventional, well-known elements that need not be explained in detail here. For example, client system 20 could include a desktop personal computer, workstation, laptop, PDA, cell phone, or any WAP-enabled device or any other computing device capable of interfacing directly or indirectly to the Internet. Client system 20 typically runs a browsing program, such as Microsoft's Internet Explorer, Netscape Navigator, Opera, or a WAP enabled browser in the case of a cell phone, PDA or other wireless device, or the like, allowing a user of client system 20 to access, process and view information and pages available to it from server systems 50ₗ to 50^{N} over Internet 40. Client system 20 also typically includes one or more user interface devices 22, such as a keyboard, a mouse, touchscreen, pen or the like, for interacting with a graphical user interface (GUI) provided by the browser on a display (e.g., monitor screen, LCD display, etc.), in conjunction with pages, forms and other information provided by server systems 50ₗ to 50_{N} or other servers. The present invention is suitable for use with the Internet, which refers to a specific global Internetwork of networks. However, it should be understood that other networks can be used instead of the Internet, such as an intranet, an extranet, a virtual private network (VPN), a non-TCP/IP based network, any LAN or WAN or the like.

According to one embodiment, client system 20 and all of its components are operator configurable using an application including computer code run using a central processing unit such as an Intel Pentium processor or the like. Computer code for operating and configuring client system 20 to process media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital video disk (DVD) medium, a floppy disk, and the like. Additionally, the entire program code, or portions thereof, may be transmitted and downloaded from a software source, e.g., from one of server systems 50ₗ to 50_{N} to client system 20 over the Internet as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing the present invention can be implemented in HTML, Java, JavaScript, or any scripting language, such as VBScript, that can be executed on a client system.

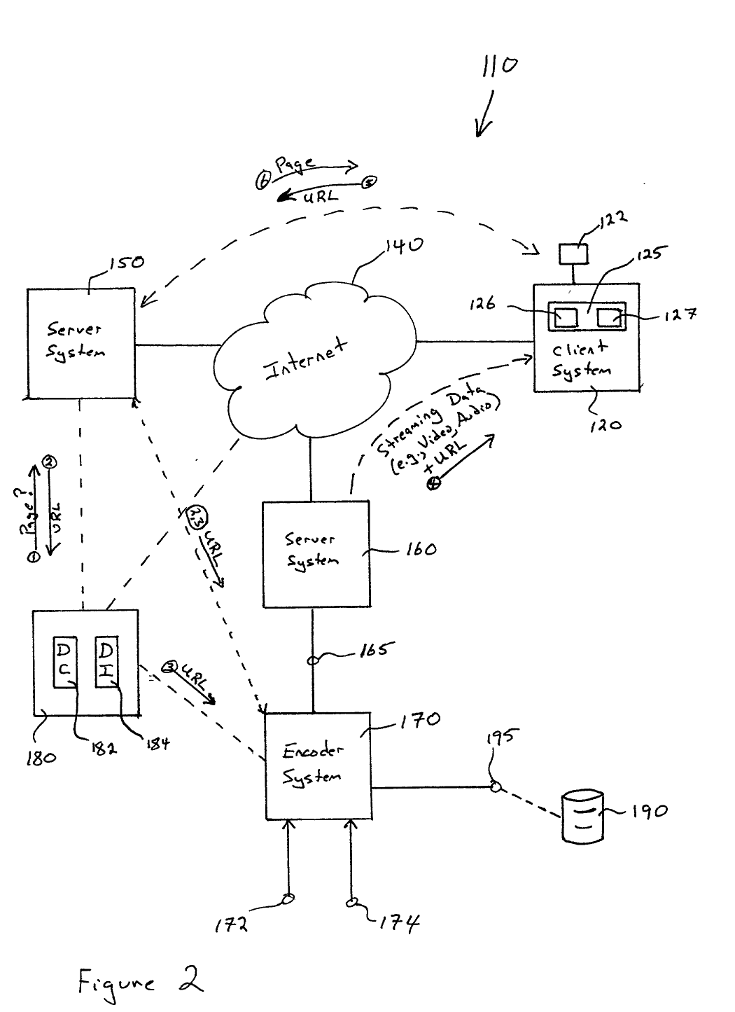

FIG. 2 illustrates another information retrieval and communication network 110 for communicating media content according to an embodiment of the invention. As shown, network 110 includes client system 120, server system 150, server system 160, media encoder system 170 and data creation and insertion system 180 (“data system 180”). In network 110, client system 120 is communicably coupled through Internet 140 or other communication network to server systems 150 and 160. As discussed above, client system 120 and its components are configured to communicate with server systems 150 and 160 and other server systems over the Internet 140 or other communication networks.

According to one embodiment, a client application (represented as module 125) executing on client system 120 includes instructions for controlling client system 120 and its components to communicate with server systems 150 and 160 and to process data content received therefrom as will be described herein. Client application 125 is preferably transmitted and downloaded to client system 120 from a software source such as a remote server system (e.g., server system 150, server system 160 or other remote server system), although client application module 125 can be provided on any software storage medium such as a floppy disk, CD, DVD, etc. as discussed above. In one embodiment, client application module 125 is provided to client system 120 in an HTML wrapper including embedded Active X controls for rendering the various objects frames and windows as will be described later. In another embodiment, the web page(s) accessed by client application module 125 loads Active X controls on the fly. Additionally, client application module 125 includes various software modules for processing data and media content, such as a media player module 126 for processing streaming media signals and a browser module 127 for rendering text and data frames and active browser windows. Further, browser module 127 may include the same browser as the default browser configured on client system 120 or it may be different. As one example, a client application module 125 according to one embodiment can be downloaded from Yahoo! Inc. at the FinanceVision site, which is located at the URL: http://financevision.yahoo.com/.

Referring to FIG. 2, according to one embodiment, server system 160 is configured to provide streaming data and media content to client system 120, and server system 150 is configured to provide data and media content such as web pages to client system 120. As will be described in more detail below, server system 160 in one embodiment provides streaming data associated with real time media presentations, such as real time video and/or audio presentations. Such presentations may be live or archived. Server system 150 and server system 160 each includes at least one server, and preferably includes multiple servers, and although shown as a single block, may be geographically distributed. For example, all servers of server system 160 may be located in close proximity to one another (e.g. in a server farm located in a single building or campus), or they may be distributed at locations remote from one another (e.g., one or more servers located in city A and one or more servers located in city B). As used herein, the term “server system” will typically include one or more logically and/or physically connected servers distributed locally or across one or more geographic locations. Additionally, the term “server” will typically include a computer system and an associated storage system and database application as is well known in the art.

Encoder system 170, according to one embodiment, is configured to receive a real time video signal 172 and/or a real time audio signal 174 and encode the real time signals into a streaming data format. In one embodiment for example, a standard Windows Media Player encoder is used to encode the real time data. The encoded data is then provided over network connection 165 to server system 160. Network connection 165 preferably includes a dedicated connection such as a T1 line, although any direct or indirect connection may be used, including the Internet. Examples of alternate or additional connection mediums include dedicated T2 or T3 lines, OC3-OC256 fiber optic cable lines, etc. Additionally, encoder system 170 may be physically located locally or remotely in relation to server system 160.

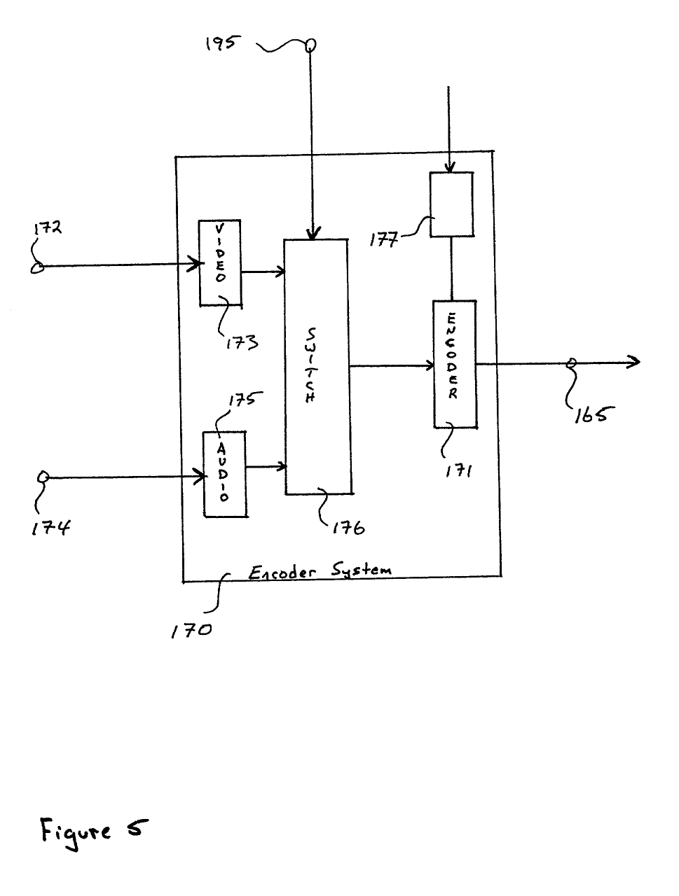

Additionally, encoder system 170 is configured to receive and process signals from computing system 190, which in one embodiment includes a database of AVI files. As will be described in more detail below with reference to FIG. 5, encoder system 170 includes a software switch configured to switch between a live feed (e.g., audio signals 174 and video signals 172) and other signals, such as signals associated with commercials, advertisements and other media content stored on computer system 190. For example, in one embodiment, real time commercials and advertisements can be stored on computer system 190 as AVI files. In this embodiment, the AVI files are preferably encoded at a low bit rate, e.g., using MPEG-4 or other encoding standard, and decoded prior to being provided to encoder system 170 in a frame accurate manner. Additionally, signals associated with advertisements and commercials can be provided over line 195 from another source, such as an advertisement server (not shown).

An advertisement GUI is also provided in one embodiment to allow an operator to control when commercials, advertisements or other content is provided to encoder system 170, and to control encoder system 170 to switch over to the data provided on line 195 from the live feed. In this embodiment, the GUI is provisioned locally, e.g., on data system 180, although any computer system connected over the Internet or over another network connection to encoder system 170 may be used. For example, a user interface provided on data system 180 provides an operator with control of both the data creation and insertion tools of data system 180 as will be described below as well as control of encoder system 170 and computer system 190. In one embodiment, the ad GUI is implemented in Java Script, although any other language or scripting language may be used. In one embodiment, the computer system executing the ad GUI communicates with an advertisement server to determine advertisements and commercials to be displayed during a media presentation or between media presentations. One such ad server is located at the URL http://www.broadcast.com.

Data system 180 is provided for creating pages related to streaming media presentations and for pushing the pages to client system 120 at the appropriate time to coincide with the streaming media presentation. In one embodiment, as shown, data creation and insertion system 180 includes data creation module 182 and data insertion module 184. Data creation module 182 allows a user to create pages of related information. Data insertion module 184 provides data to encoder system 170 for insertion into the data stream sent over line 165. Data creation and insertion system 180 is implemented in a PC or other computing device and is communicably coupled to server system 150 and encoder system 170 over either a direct connection or an indirect connection such as Internet 140, and may be physically located proximal server system 150 or encoder system 170 or both.

In one embodiment, data creation module 182 provides a user with a publishing tool for creating pages of information related to real time media presentations using templates, e.g., HTML layout template. The data creation module 182 allows the user to select from a number of pre-defined web pages (data windows) or create a web page dynamically. In one embodiment, the user selects a pre-made template, or creates a new template and provides the desired data, URLs/links, etc. into the fields presented by the template. When finished entering information, the user is able to preview the created page, and if satisfied, the user commits the page. Information and data included in the pages can include graphs, stock quote ticker symbols, URLs and hyperlinks, and other graphical and text information as desired. After a page is committed, data system 180 transmits the page to server system 150. Server system 150 returns an IP address, e.g., URL, for the location of the stored page either immediately or when requested later by data system 180.

Data insertion module 184 communicates with encoder system 170 and provides data to be inserted into the data stream created by encoder system 170. For example, in one embodiment, data insertion module 184 provides reference data, typically including a URL or IP address, identifying a specific page stored on server system 150 to encoder system 170 for insertion into a data stream. If data system 180 does not already have the reference data identifying the specific page, data system 180 requests (e.g., HTTP request) the reference data from server system 150. Alternatively, server system 150 is configured to send the reference data, e.g., URL, directly to encoder system 170. For example, in this embodiment, with reference to FIGS. 2 and 5, server system 150 may be configured to execute a Visual Basic script that calls a COM object resident on communications module 177 of encoder system 170 and sends the URL to the encoder system 170. The reference data is inserted into the data stream by encoder system 170, and when ultimately received by client application 125, client application 125 automatically performs an HTTP data request using the received reference data to obtain the web page from server system 150 for simultaneous display with the real time media presentation. Data insertion module 184 may operate automatically to send the reference data to encoder system 170 at the appropriate time, or data insertion module 184 may be user-controlled to send the reference data at the appropriate time.

Pages may be created well in advance of a related media presentation. For example, a producer, when designing a media broadcast or a “rundown” of shows, may create various pages for various show segments and send the finished templates to server system 150. When it is desired that a page be pushed to client system 120, data system 180 requests the reference data, e.g., URL or IP address, identifying the desired page from server system 150. Server system 150 returns the reference data for the requested page, and data system 180 provides the reference data to encoder system 170 for insertion into the data stream for the real time media presentation. Upon receiving the data stream from server system 160, client system 120 (module 125) displays the real time media presentation on one portion of a display and automatically requests and displays the page from server system 150 using the received reference data. In this manner, each page may be created well in advance, e.g., days weeks, months, of a related real time media presentation, yet each page will include fresh current data when actually requested and displayed by client system 120. In general, it is preferable to send a reference, e.g., URL or IP address, of a page rather than the page itself to conserve bandwidth and so that the data in the page is fresh when retrieved and displayed by client system 120.

In this description it is assumed that a web page is formatted using hypertext markup language (HTML) commands, although the present invention is also equally applicable to processing web pages formatted using any markup language including any instance of the Standard Generalized Markup Language (SGML), such as XML, WML, HDML (for hand-held devices), DHTML and others.

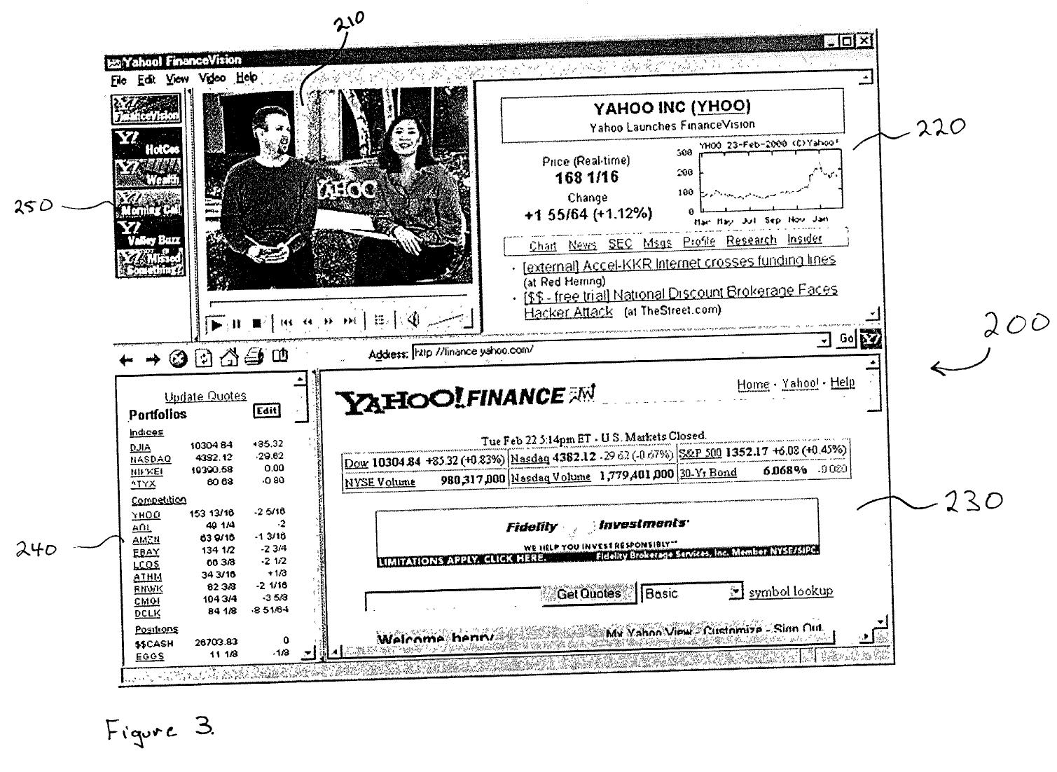

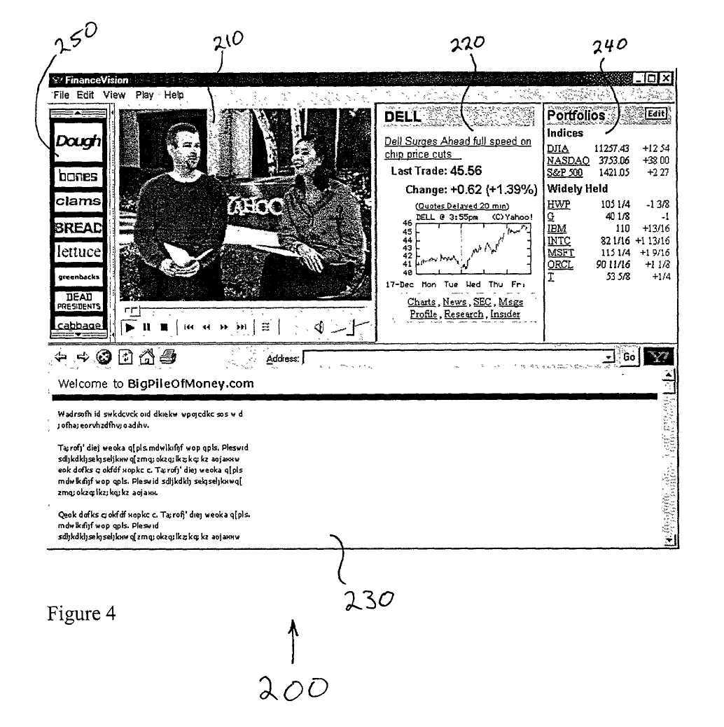

FIG. 3 illustrates an example of a graphical user interface (GUI) display 200 created by application 125 according to an embodiment of the present invention. As shown, GUI 200 includes various subwindows or frames for displaying various data and media content. GUI 200 in one embodiment includes a real time media presentation frame 210 (“media frame 210”) and a data frame 220. Also shown in FIG. 3 in a “full view” mode are optionally provided active browser window 230, portfolio window 240 and channel bar 250. Other viewable modes and window arrangements are possible. For example, according to one embodiment, in an “expanded view” mode, all windows and frames except browser window 230 are displayed, and in a “compact view” mode, only media frame 210 and channel bar 250 are displayed. Additionally, FIG. 4 illustrates an example of a different arrangement of windows and frames.

Media frame 210 is provided for displaying a video presentation or in the case of an audio presentation, a related graphical or video display. For example, FIG. 4 shows an audio presentation with a graphical display in media frame 210. As shown in the Figures, media frame 210 is reduced in size relative to the entire viewable display to allow for other media objects and windows to be presented. Additionally, because the frame size is reduced, the necessary bandwidth required to send and display the real time media presentation is reduced. For example, for video, a 320×200 pixel video frame can be displayed using bandwidths of 100K (e.g., 128K ISDN connection) and 300K (e.g., DSL, cable modem, T1-T3 LAN connections, etc.), and a 176×132 pixel video frame can be displayed using a 56K stream (e.g., 56K dial-up modem connection). To conserve bandwidth, for video broadcasts, the user is given the option to play the audio portion only. As shown, media frame 210 is approximately 330×300 pixels with the control bar and borders. The size of media frame 210 may be fixed or it may be resizable, e.g., using ASX parameters embedded in the data stream.

Data frame 220 displays data and pages pushed to client application 125 in the real time media presentation data stream. For example, when a URL is passed to client application 125 in the data stream as described above, client application 125 sends an HTTP request to server system 150 using the URL and displays the resulting HTML page received from server system 150 in data frame 220. As shown, data frame 220 has a size of 208×300 pixels. Data frame 220 is preferably resizable, either manually or automatically, e.g., using ASX controls embedded in the data stream. Also as shown, the page displayed in data frame 220 includes one or more hyperlinks. Upon selection of a hyperlink by a user, e.g., using a mouse or other pointing device, the link is passed to browser window 230, an HTTP request is sent to the IP address associated with the hyperlink and the resulting HTML is displayed in the browser window 230. If browser window 230 is not open, selection of a link in data frame 220 causes active browser window 230 to open and display the received media content identified by the selected link. Browser window 230 is preferably a scaled down version of Internet Explorer 5.0 or higher, although any browser may be used, e.g., Netscape Navigator, Opera or the like. Additionally as shown, browser window 230 can be scrolled. Browser window 230 includes an editable address bar, scroll bars and control icons as are well known.

Portfolio window 240 displays additional information retrieved from a remote source such as server system 150 or another server system. According to one embodiment, for example, client application 125 is configured to retrieve user configured data content from the My Yahoo! server system, which is located at the URL http://my.yahoo.com, if a portfolio has been created and the user's cookie is still valid. An example of such a system for creating, maintaining and processing user configured data is provided in U.S. Pat. No. 5,983,227, entitled “Dynamic Page Generator,” and assigned to Yahoo! Inc., the contents of which are herein incorporated by reference in its entirety. As shown in FIG. 3, the data content for portfolio window 240 is formatted to fit within a 167×300 pixel area. If the data content is longer than 167 pixels, horizontal and vertical scroll bars are displayed. Portfolio window 240 may also include links, which when selected are passed to the browser window as above.

Channel bar 250 includes one or more links, e.g., displayed as icons, identifying the live and archived media broadcast content available to a user. Upon selection of a channel link for archived content, the user is presented with a list of archived content available, e.g., in a pop-up dialog box. The user selects a particular archived broadcast, and an HTTP request is sent to server system 160, which responds by sending the data stream for the desired media broadcast to client system 120 for display in media frame 210. Upon selection of a live channel, the identified live broadcast is similarly displayed. When a channel is selected, the icon is highlighted, or otherwise made more prominent, while it is active. In one embodiment, a main channel, “FinanceVision” as shown, is set as a default channel upon startup. FinanceVision refers to a live video broadcast produced by Yahoo! Inc. discussing financial news and events. Additionally, after completion of an archived presentation segment, the main default channel loads again and resumes playing. In one embodiment, the main channel, in this case FinanceVision, is presented more prominently, e.g., taller, and does not scroll if the channel bar is made to scroll. The channel bar is preferably scrollable if the number of channels available do not fit within the defined channel bar area. If displayed, the scroll bars are disabled unless enough channels are present to enable scrolling. As shown, channel bar 250 is a fixed size of 80×300 pixels, but may be resizable.

FIG. 4 illustrates another example of a GUI display 200 created by application 125 according to an embodiment of the present invention. As shown, browser window 230 is expanded to cover the entire bottom portion of the display, and data frame 220 is reduced in size to share space with portfolio window 240.

In FIGS. 3 and 4, the pages of data content retrieved from server system 150 and displayed in data frame 220, including links to other content, are preferably tied to the subject matter of the current video shot displayed in media frame 210 (or in the case of audio only, the data content is preferably tied to the subject matter of the current topic of discussion). For example, in FIG. 3, the displayed hosts of the video presentation may be discussing news related to Yahoo! Inc. Displayed concurrently in data frame 220 is a page of related information regarding Yahoo! Inc, such as a stock quote (real time or delayed) a graph of stock price v. time and links to related news stories. Similarly, in FIG. 4, the hosts may be discussing a story related to Dell Computer Corporation, and a page of related data content including links is displayed in data frame 220. Other data content related to media broadcasts that may be displayed includes information on the speaker/host, a link to the speaker's web site, etc. For example, in the context of a news broadcast (audio or video), as one speaker in the news program begins to speak, the speaker's name is displayed in data frame 220 along with selectable HTML links to further information on that speaker or the topic. As the subject of the media presentation changes or a new speaker is interviewed, the new speaker's name may be displayed along with links or other related content. In the context of auctions, for example, information such as a picture of the item(s) being auctioned, the current bid price, time of last bid, etc., may be displayed in data frame 220. If a commercial or advertisement is displayed in media frame 210, e.g., during a break in a live broadcast, page(s) of information related to the commercial or advertisement may be created and displayed in data frame 220 as above.

In one embodiment, a page presented in data frame 220 allows the user of client system 120 to submit a question or comment to the current host or speaker of a live broadcast. For example, in one embodiment, a hyperlink identifying a question form on a remote computer system, e.g., data system 180 or server system 150, is included in the page. Upon selection of this hyperlink, the remote computer system sends the question form to client system 120. The user fills in a question or comment in the field(s) provided and submits the form, e.g., by selecting a “finished” icon, or selecting “enter”. The form is then sent back to the remote computer system or to another remote computer system for viewing by a producer of the live broadcast. The producer, if satisfied with the question/comment, provides the question/comment to the host, e.g., via a video teleprompter, for a live response. Additionally, the producer may, in real time, also create and upload using data creation and insertion system 180, another web page, e.g., a “question page”, including the question/comment to server system 150 so that the question may be presented to all viewers of the live broadcast during the live response. As above, server system 150 returns the reference data, e.g., URL, for the question page to data system 180, which then sends the reference data to encoder system 170 for insertion into the current live broadcast data stream. When received, client system 120 retrieves the web page including the question/comment from server system 150 using the received reference data and displays the question page in data frame 220 concurrently with the live response.

Client application 125 is controlled from a remote location according to one embodiment. In this embodiment, client application 125 is configured to instruct client system 120 to periodically poll one or more predetermined URLs to obtain updates for data frame 220 and other elements in the display. For example, client system 120 may poll server system 150 to obtain updates to the page displayed in data frame 220 using the reference data passed in the data stream from server system 160, and client system 120 may periodically poll server system 150 or another server system to obtain updates to the graphical elements provided in the GUI produced by client application 125. Additionally, client system 120 may periodically poll the My Yahoo! server to obtain updates to the portfolio page. In this manner, pages displayed in data frame 220 can be automatically refreshed. For example, if as shown in FIG. 3, the page displayed in data frame 220 includes a stock quote (real time or delayed) the quote is automatically updated each time the page is refreshed. Similarly, data displayed in portfolio window 240 may be refreshed periodically. Additionally, data displayed in portfolio window 240 and browser window 230 can be manually refreshed, e.g., by selecting a refresh icon.

FIG. 5 is a block diagram of encoder system 170 according to an embodiment of the present invention. In preferred aspects encoder system 170 is implemented as hardware and software in a computer system such as a PC or a server. As shown, encoder system 170 includes encoder module 171, video driver module 173, audio driver module 175, switch module 176, and communication module 177. Encoder module 171 in one embodiment includes a standard Microsoft Windows media encoder, although any other encoder such as a Real Networks encoder or a QuickTime encoder may be used. Encoder module 171 encodes the streaming signals received from switch 176 and transmits the encoded signals over line 165 to server system 160. Encoder 171 in one embodiment, is capable of inserting a data event, such as a URL, into a data stream.

Video module 173 includes a video capture card and associated software drivers for receiving and processing video signals received over line 172. In one embodiment, an Osprey 100 video card is used although any video card capable of processing real time video signals may be used. Similarly, audio module 175 includes an audio capture card such as an Antex LX-44 card and associated software drivers for receiving and processing audio signal received over line 174. Alternatives audio capture cards include SoundBlaster cards, etc. Switch 176 emulates a capture card driver and functions to switch the signals provided to encoder module 171 between AVI signals received over line 195, e.g., from computer system 190 or an ad server, and audio and video signals received from audio module 175 and video module 173, respectively. Switch module 176 allows for operator control of which signals are provided to encoder module 171 when encoder module 171 requests data from a capture card. For example, using a GUI as displayed on data system 180, or other computer system, as described above, an operator is able to control switch module 176 and thus the overall media presentation. In this manner, switch module 176 provides an operator with control to switch between a live feed, e.g., real time audio and video signals on lines 172 and 174, and signals for on demand AVI files or other on demand media files, over line 195.

Communication module 177 provides a communication link with encoder module 171. Communication module 177 is used in one embodiment to provide control, remote or otherwise, of encoder 171. For example, in one embodiment, data system 180 communicates with encoder 171 via communication module 177 to provide data, such as the URL of a web page related to the content of the data stream, for insertion into the data stream to be provided to server system 160. The URL is preferably inserted into the stream in realtime, as the video signal is being encoded. In one embodiment, communication module 177 preferably includes a cgi script to facilitate remote communication. Alternatively, communication module 177 includes a direct interface to allow a user operating the computer system embodying the encoder system to control encoder module 171. Thus, an operator is able to change the pages displayed in data frame 220 of client system 120 and other client systems by “flicking a switch” (e.g., selecting a pre-created page on a GUI) to cause a new URL to be inserted into the data stream. For example, in one embodiment, a producer of a live broadcast can change pages displayed on the data frames 220 of viewers systems 120 in real time by selecting a pre-created page(s) and sending the associated reference data to encoder system 170 at the appropriate time. Thus, during the course of a live broadcast, as the topic changes, the producer can direct the related pages pushed to client systems 120 to change in real time.

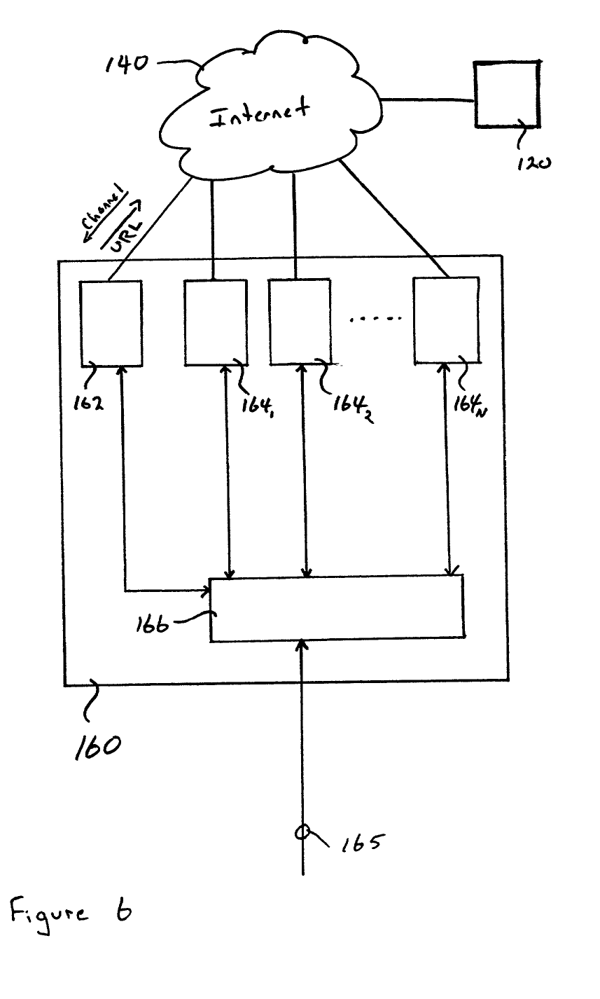

FIG. 6 illustrates an expanded view of server system 160 according to an embodiment of the present invention. As shown, server system 160 includes a playlist server 162, a plurality of streaming data servers 164₁-164_{N} and a content management system 166. Servers 164 are preferably distributed locally, e.g., as a server farm, but they may be geographically remotely distributed. Playlist server 162 interfaces with client systems to determine a particular server 164 associated with a particular broadcast, live or archived. For example, in one embodiment, when a user of client system 120 selects a channel in channel bar 250, an HTTP request is sent to playlist server 162. Playlist server 162 resolves the request to a particular server 164 and sends back an IP address or URL identifying the particular server 164 to client system 120. Client system 120 then communicates with the particular identified server 164 to receive a data stream (e.g., live or archived, video or audio) associated with the selected channel. In one embodiment, a load table is maintained that lists all of the streaming data servers 164 and which files (data streams) are loaded on which servers 164. The streaming data servers 164 are preferably identified through their IP addresses, and the table lists which IP addresses hold which files (data streams). When a request to play a specific file is received, the playlist server 162 performs a lookup on the load table and sends back the IP address to which the requesting client system 120 should link to get the desired file. In this manner, the load on the network is distributed so that no single streaming server 164 is overloaded when streaming to many clients for a given file (data stream). The load table is stored on content management system 166, but may additionally, or alternatively, be stored on playlist server 162.

Content management system 166 is provided for streaming data among servers 164 and to allow an operator to control the weightings of each of servers 164, e.g., based on the weight of activity of each server. For example, in one embodiment, each server 164 reports activity to management system 166 on a periodic basis, e.g., every 15 seconds. Management system 166 compiles the activity reports and presents an activity report to an operator via a GUI. The operator may manually change the weighting of each individual server 164 to redistribute the load on the servers 164 accordingly. Alternately, management system 166 is configured to automatically change the weightings of servers 164 based on a predetermined algorithm, e.g., a monte carlo algorithm.

After a live broadcast is completed and uploaded to server system 160, an operator is able to edit the (now stored) broadcast to create an archived broadcast for later presentation on client systems 120. For example, using a GUI on data system 180, or other computer system, a producer of a broadcast show can select certain portions and segments to store as an archived broadcast. Reference data, e.g., URLs and IP addresses, identifying the pages of related information associated with the selected portions and segments of the broadcast are also stored. In this manner, when a user of a client system 120 views an archived broadcast, they are also presented with fresh current data in data frame 220. In the case of a page including a stock quote, for example, the stock quote will be updated to reflect the current value and not the value as of the time of the original live broadcast.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer implemented method of displaying interactive media content, the method comprising the steps of:
receiving a data stream from a first server system over a network connection, wherein the data stream includes a first data portion corresponding to a real time media presentation and a second data portion identifying data for a related web page stored on a second server system;
processing the first data portion to produce the real time media presentation;
automatically retrieving the web page data from the second server system; and
simultaneously displaying the real time media presentation and the web page on different portions of a display.

2. The computer implemented method of claim 1, further comprising the step of sending a request to the first server system identifying the data stream in response to a user selection of the real time media presentation.

3. The computer implemented method of claim 1, further comprising the steps of:
sending a request to the first server system identifying a second real time media presentation in response to a user selection of the second real time media presentation;
receiving a second data stream from the first server system over the network connection, wherein the second data stream includes a first data portion corresponding to the second real time media presentation and a second data portion identifying data for a second related web page stored on the second server system;
processing the first data portion of the second data stream to produce the second real time media presentation;
automatically retrieving the second web page data from the second server; and
simultaneously displaying the second real time media presentation and the second web page on the different portions of the display.

4. The computer implemented method of claim 3, wherein the second real time media presentation corresponds to one of an archived video presentation and an archived audio presentation.

5. The computer implemented method of claim 3, wherein the first real time media presentation corresponds to one of a live broadcast video presentation and a live broadcast audio presentation.

6. The computer implemented method of claim 1, wherein the data stream further includes a third data portion identifying data for a second related web page stored on the second server system, wherein the method further comprises the steps of:
automatically retrieving the second web page data from the second server system after the third data portion is received, wherein the second web page is related to the current subject matter of the real time media presentation; and
replacing the first web page with the second web page such that the real time media presentation and the second web page are simultaneously displayed on the different portions of the display.

7. The computer implemented method of claim 6, wherein the second web page includes a selectable link to data content on a third server system.

8. The computer implemented method of claim 1, wherein the second data portion includes a link identifying the related web page data on the second server system, wherein the step of automatically retrieving the related web page includes:
automatically sending a request for the web page data to the second server system using the link; and
receiving the web page data from the second server system over the network connection.

9. The computer implemented method of claim 8, wherein the link includes an IP address identifying a location on the second server system, and wherein the request is an HTTP request.

10. The computer implemented method of claim 1, further comprises the step of:
displaying an active browser window in a third portion of the display simultaneous with displaying the real time media presentation and the web page in first and second portions of the display.

11. The computer implemented method of claim 10, wherein the displayed web page includes a selectable link to data content on a third server system, and wherein the method further comprises the steps of:
retrieving the data content from the third server system in response to a user selection of the link; and
displaying a media presentation based on the data content in the browser window.

12. The computer implemented method of claim 11, wherein the link includes one of a uniform resource locator and a hyperlink, and wherein the step of retrieving includes sending an HTTP request to the third server system.

13. The computer implemented method of claim 11, further includes the steps of:
providing the data content to a browser module; and
processing the data content to produce the media display using the browser module.

14. The computer implemented method of claim 11, wherein the browser module is one of an Internet Explorer module, a Netscape Navigator module and an Opera module.

15. The computer implemented method of claim 11, wherein the data content includes HTML code.

16. The computer implemented method of claim 1, wherein the real time media presentation is one of a video presentation and an audio presentation.

17. The computer implemented method of claim 1, wherein the step of processing the first data portion includes:
providing the first data portion to a media player module; and
decoding the first data portion in the media player module to produce the real time media presentation.

18. The computer implemented method of claim 17, wherein the media player is one of a Windows Media Player and a RealNetworks Player.

19. The computer implemented method of claim 1, wherein the web page data includes HTML code.

20. The computer implemented method of claim 1, further comprising the steps of retrieving a personal page from a third server system and displaying the personal page on a third portion of the display simultaneous with displaying the real time media presentation and the web page on first and second portions of the display, wherein the personal page includes user configured information.

21. The computer implemented method of claim 1, further comprising the step of displaying a channel bar in a third portion of the display simultaneous with displaying the real time media presentation and the web page in first and second portions of the display, wherein the channel bar includes selectable links for a plurality of channels.

22. The computer implemented method of claim 21, further including, in response to a user selection of a first one of the links, sending a request to the first server system identifying the data stream, wherein the data stream corresponds to a first one of the channels.

23. The computer implemented method of claim 21, wherein the data stream corresponds to a first one of the channels, the method further including the steps of:
in response to a user selection of a first one of the links, sending a request to the first server system identifying a second real time media presentation corresponding to a second one of the channels;
receiving a second data stream from the first server system over the network connection, wherein the second data stream includes a first data portion corresponding to the second real time media presentation and a second data portion identifying data for a second related web page stored on the second server system;
processing the first data portion of the second data stream to produce the second real time media presentation;
automatically retrieving the second web page data from the second server; and
simultaneously displaying the second real time media presentation and the second web page on the different portions of the display.

24. The computer implemented method of claim 21, wherein each channel corresponds to a different real time media presentation available from the first server system.

25. The computer implemented method of claim 1, wherein the network connection includes an Internet connection.

26. The computer implemented method of claim 1, wherein the real time media presentation includes content related to one of financial news and information, sporting news and information, shopping, auctions, and general news and information.

27. The computer implemented method of claim 26, wherein the web page includes content related to the content of the real time media presentation.

28. The computer implemented method of claim 1, further including automatically updating the web page by periodically polling the second server system.

29. A computer implemented method of displaying interactive media content, the method comprising the steps of:
receiving a first data stream from a first server system over a network connection, wherein the first data stream includes a first data portion corresponding to a real time media presentation and a second data portion including an IP address identifying data for a web page on a second server system;
processing the first data portion using a media player module to produce the real time media presentation;
displaying the real time media presentation in a first portion of a display;
automatically sending a request for the web page data to the second server system using the IP address;
receiving the web page data from the second server system;
processing the web page data using a browser module to produce the web page; and
displaying the web page on a second portion of the display simultaneous with displaying the real time media presentation.

30. The computer implemented method of claim 29, further comprises the step of:
displaying an active browser window using the browser module in a third portion of the display simultaneous with displaying the real time media presentation and the web page.

31. The computer implemented method of claim 30, wherein the web page includes a selectable link to data content on a third server system, and wherein the method further comprises the steps of:
retrieving the data content from the third server system in response to a user selection of the link; and
displaying the data content in the browser window.

32. The computer implemented method of claim 30, wherein the link is a hyperlink, and wherein the step of retrieving includes sending an HTTP request to the third server system.

33. The computer implemented method of claim 29, wherein the real time media presentation is one of a video presentation and an audio presentation.

34. The computer implemented method of claim 29, wherein the step of processing the first data portion includes decoding the first data portion in the media player module to produce the real time media presentation.

35. The computer implemented method of claim 34, wherein the media player is one of a Windows Media Player and a RealNetworks Player.

36. The computer implemented method of claim 29, wherein the subject matter of the web page is related to the subject matter of the real time media presentation.

37. The computer implemented method of claim 29, wherein the request is an HTTP request.

38. The computer implemented method of claim 29, wherein the browser module is one of an Internet Explorer module, a Netscape Navigator module and an Opera module.

39. The computer implemented method of claim 29, further comprising the steps of:
sending a request to the first server system identifying a second real time media presentation in response to a user selection of the second real time media presentation;
receiving a second data stream from the first server system over the network connection, wherein the second data stream includes a first data portion corresponding to the second real time media presentation and a second data portion including a second IP address identifying data for a second related web page stored on the second server system;
processing the first data portion of the second data stream using the media player module to produce the second real time media presentation;
automatically sending a second request for the second web page data to the second server system using the second IP address;
receiving the second web page data from the second server system;
processing the second web page data using the browser module to produce the second web page; and
simultaneously displaying the second real time media presentation and the second web page on the different portions of the display.

40. The computer implemented method of claim 29, wherein the first data stream further includes a second IP address identifying data for a second related web page stored on the second server system, wherein the method further comprises the steps of:
after the third data portion is received, automatically sending a second request for the second web page data to the second server system using the second IP address;
receiving the second web page data from the second server system;
processing the second web page data using the browser module to produce the second web page, wherein the second web page is related to the current subject matter of the real time media presentation; and
replacing the first web page with the second web page such that the real time media presentation and the second web page are simultaneously displayed on the different portions of the display.

41. The computer implemented method of claim 40, wherein the second web page includes a selectable link to data content on a third server system.

42. The computer implemented method of claim 29, further comprising the steps of retrieving a personal page from a third server system and displaying the personal page on a third portion of the display simultaneous with displaying the real time media presentation and the web page on first and second portions of the display, wherein the personal page includes user configured information.

43. The computer implemented method of claim 42, further including the step of downloading the client application to the client device over the network connection.

44. The computer implemented method of claim 29, wherein the real time media presentation includes content related to one of financial news and information, sporting news and information, shopping, auctions, and general news and information.

45. The computer implemented method of claim 44, wherein the web page includes content related to the content of the real time media presentation.

46. The computer implemented method of claim 29, wherein the browser module and media player modules are integrated in a client application executing on a client device and configured to perform the steps of the method.

47. The computer implemented method of claim 29, further including automatically updating the web page by periodically polling the second server system using the IP address.

48. The computer implemented method of claim 29, further comprising the step of displaying a channel bar in a third portion of the display simultaneous with displaying the real time media presentation and the web page in first and second portions of the display, wherein the channel bar includes selectable links for a plurality of channels.

49. The computer implemented method of claim 48, wherein each channel corresponds to a different real time media presentation available from the first server system.

50. An information display system comprising:
a first server that provides data associated with a web page in response to a data request;
a second server that provides a data stream including streaming data associated with a real time media presentation and reference data identifying the web page data on the first server; and
a client application executing on a client device communicably coupled to the first and second servers over the Internet, the client device including a processing unit and a display,
wherein the client application includes instructions for controlling the client device to:
receive the data stream from the second server;
process the streaming data to produce the real time media presentation;
automatically retrieve the web page data from the first server using the reference data;
process the web page data to produce the web page; and
simultaneously display the real time media presentation and the web page on different portions of the display.

51. The system of claim 50, wherein the application further includes instructions for updating the web page by periodically polling the first server using the reference data.

52. The system of claim 50, wherein the client application includes:
a media player module, wherein the media player module processes the streaming data to produce the real time media presentation; and
a browser module, wherein the browser module processes the web page data to produce the web page.

53. The system of claim 52, wherein the client application further includes instructions to produce an active browser window using the browser module, and to display the active browser window on a third portion of the display simultaneous with displaying the real time media presentation and web page on first and second portions of the display.

54. The system of claim 53, wherein the displayed web page includes a selectable link to data content on a third server, and wherein the client application further includes instructions for:
retrieving the data content from the third server in response to a user selection of the link; and
displaying the data content in the active browser window.

55. The system of claim 54, wherein the link is a hyperlink, and wherein the instructions for retrieving include instructions for sending an HTTP request to the third server.

56. The system of claim 52, wherein the browser module includes one of a an Internet Explorer browser, a Netscape Navigator browser and an Opera browser, and wherein the media player module includes one of a Windows Media Player and a RealNetworks Player.

57. The system of claim 50, wherein the reference data includes an IP address identifying the web page data on the second server.

58. The system of claim 50, wherein the real time media presentation is one of a video presentation and an audio presentation.

59. The system of claim 50, wherein the application further includes instructions for:
sending a request to the first server identifying a second real time media presentation in response to a user selection of the second real time media presentation;
receiving a second data stream from the first server, wherein the second data stream includes a first data portion corresponding to the second real time media presentation and a second data portion including a second IP address identifying data for a second related web page stored on the second server;
processing the first data portion of the second data stream to produce the second real time media presentation;
automatically sending a second request for the second web page data to the second server using the second IP address;
receiving the second web page data from the second server;
processing the second web page data to produce the second web page; and
simultaneously displaying the second real time media presentation and the second web page on the different portions of the display.

60. The system of claim 50, wherein the first data stream further includes a second IP address identifying data for a second related web page stored on the second server, wherein the application further includes instructions for:
after the third data portion is received, automatically sending a second request for the second web page data to the second server using the second IP address;
receiving the second web page data from the second server;
processing the second web page data to produce the second web page, wherein the second web page is related to the current subject matter of the real time media presentation; and
replacing the first web page with the second web page such that the real time media presentation and the second web page are simultaneously displayed on the different portions of the display.

61. The system of claim 60, wherein the second web page includes a selectable link to data content on a third server.

62. The system of claim 50, wherein the application further includes instructions for retrieving a personal page from a third server and displaying the personal page on a third portion of the display simultaneous with displaying the real time media presentation and the web page on first and second portions of the display, wherein the personal page includes user configured information.

63. The system of claim 50, wherein the application further includes instructions for displaying a channel bar on a third portion of the display simultaneous with displaying the real time media presentation and the web page in first and second portions of the display, wherein the channel bar includes selectable links for a plurality of channels.

64. The system of claim 63, wherein each channel corresponds to a different real time media presentation available from the second server.

65. The system of claim 63, wherein the application further includes instructions for sending a request to the second server identifying a second data stream in response to a selection of one of the channel links.

66. A computer implemented method of displaying interactive media content, comprising:
displaying a real time media presentation on a first portion of a display, wherein the real time media presentation is based on streaming data received from a first server system; and
simultaneously displaying a web page on a second portion of the display, wherein the web page is automatically retrieved from a second server system using reference data included in the streaming data.

67. The method of claim 66, further comprising simultaneously displaying an active browser window on a third porion of the display.

68. The method of claim 66, wherein the web page is automatically updated by periodically polling the second server system using the reference data.

69. The computer implemented method of claim 66, wherein the displayed web page includes a selectable link to data content on a third server system, wherein the method further includes displaying the data content in the active browser window in response to a selection of the link.

70. The computer implemented method of claim 73, wherein the displayed data content includes a second link to media content on a fourth server system.

71. The computer implemented method of claim 66, further comprising:
simultaneously displaying a personal page on a third portion of the display, wherein the personal page includes user configured information retrieved from a third server system.

72. The computer implemented method of claim 66, further comprising:
simultaneously displaying a channel bar on a third portion of the display, wherein the channel bar includes selectable links for a plurality of channels.

73. The computer implemented method of claim 72, wherein each channel corresponds to a different real time media presentation available from the first server system.

74. The computer implemented method of claim 72, further comprising displaying a second real time media presentation on the first portion of the display in response to a selection of one of the channel links.

75. The computer implemented method of claim 66, further comprising:
simultaneously displaying a personal page on a third portion of the display, wherein the personal page includes user configured information received from a third server system; and
simultaneously displaying a channel bar on a fourth portion of the display, wherein the channel bar includes selectable links for a plurality of channels.

76. The computer implemented method of claim 66, further comprising:
simultaneously displaying a personal page on a third portion of the display, wherein the personal page includes user configured information received from a third server system;
simultaneously displaying a channel bar on a fourth portion of the display, wherein the channel bar includes selectable links for a plurality of channels; and
simultaneously displaying an active browser window on a fifth portion of the display.

77. A computer-readable medium containing computer code for controlling a computer system to process media content, the computer system being communicably coupled to first and second server systems over the Internet, wherein the computer system includes a processing unit and a display, wherein the first server system provides data associated with a web page in response to a data request, wherein the second server system provides a data stream including streaming data associated with a real time media presentation and reference data identifying the web page data on the first server system, and wherein the computer code includes instructions for:
receiving the data stream from the second server system;
processing the streaming data to produce the real time media presentation;
automatically retrieving the web page data from the first server system using the reference data;
processing the web page data to produce the web page; and
simultaneously displaying the real time media presentation and the web page on different portions of the display.

78. The computer-readable medium of claim 77, wherein the code further includes instructions for updating the web page by periodically polling the first server system using the reference data.

79. The computer-readable medium of claim 77, wherein the code includes:
a media player module, wherein the media player module processes the streaming data to produce the real time media presentation; and
a browser module, wherein the browser module processes the web page data to produce the web page.

80. The computer-readable medium of claim 77, wherein the code further includes instructions for producing an active browser window, and for displaying the active browser window on a third portion of the display simultaneous with displaying the real time media presentation and web page on first and second portions of the display.

81. The computer-readable medium of claim 80, wherein the displayed web page includes a selectable link to data content on a third server system, and wherein the code further includes instructions for:
retrieving the data content from the third server system in response to a user selection of the link; and
displaying the data content in the active browser window.

82. The computer-readable medium of claim 8 1, wherein the link is a hyperlink, and wherein the instructions for retrieving include instructions for sending an HTTP request to the third server system.

83. The computer-readable medium of claim 77, wherein the reference data includes an IP address identifying the web page data on the second server system.

84. The computer-readable medium of claim 77, wherein the real time media presentation is one of a video presentation and an audio presentation.

85. The computer-readable medium of claim 77, wherein the code further includes instructions for:
sending a request to the first server system identifying a second real time media presentation in response to a user selection of the second real time media presentation;
receiving a second data stream from the first server system, wherein the second data stream includes a first data portion corresponding to the second real time media presentation and a second data portion including an IP address identifying data for a second related web page stored on the second server system;
processing the first data portion of the second data stream to produce the second real time media presentation;
automatically sending a second request for the second web page data to the second server system using the IP address;
receiving the second web page data from the second server system;
processing the second web page data to produce the second web page; and
simultaneously displaying the second real time media presentation and the second web page on the different portions of the display.

86. The computer-readable medium of claim 77, wherein the first data stream further includes an IP address identifying data for a second related web page stored on the second server system, wherein the code further includes instructions for:
after the third data portion is received, automatically sending a second request for the second web page data to the second server system using the IP address;
receiving the second web page data from the second server system;
processing the second web page data to produce the second web page, wherein the second web page is related to the current subject matter of the real time media presentation; and
replacing the first web page with the second web page such that the real time media presentation and the second web page are simultaneously displayed on the different portions of the display.

87. The computer-readable medium of claim 86, wherein the second web page includes a selectable link to data content on a third server system.

88. The computer-readable medium of claim 77, wherein the code further includes instructions for retrieving a personal page from a third server system and displaying the personal page on a third portion of the display simultaneous with displaying the real time media presentation and the web page on first and second portions of the display, wherein the personal page includes user configured information.

89. The computer-readable medium of claim 77, wherein the code further includes instructions for displaying a channel bar on a third portion of the display simultaneous with displaying the real time media presentation and the web page in first and second portions of the display, wherein the channel bar includes selectable links for a plurality of channels.

90. The computer-readable medium of claim 89, wherein each channel corresponds to a different real time media presentation available from the second server system.

91. The computer-readable medium of claim 89, wherein the code further includes instructions for sending a request to the second server system identifying a second data stream in response to a selection of one of the channel links.
